(19) United States
(12) Patent Application Publication
(10) Pub. No.: US 2016/0335600 A1
(43) Pub. Date: Nov. 17, 2016

(54) AUTOMATED TALENT NURTURING

(71) Applicant: Linkedln Corporation, Mountain View, CA (US)

(72) Inventors: Raviraj Jain, San Francisco, CA (US); Kathleen Garvey, Mountain View, CA (US); Christopher L. Mann, Fairfax, CA (US); Peter Rigano, San Francisco, CA (US); Matthew Rendely, San Francisco, CA (US)

(21) Appl. No.: 14/713,865

(22) Filed: May 15, 2015

(51) Int. Cl. G06Q 10/10; G06Q 50/00

(52) U.S. Cl. CPC G06Q 10/1053; G06Q 50/01

(57) ABSTRACT

A system and method for automatically targeting content to recruiting candidates are provided. A set of users that satisfy one or more search criteria is identified as candidates. A recruiting system assigns each candidate to a nurture flow that comprises multiple segments, each segment associated with one or more actions to perform relative to the candidate, such as sending certain content to the candidate through one or more delivery channels. In one approach, each candidate's progress is tracked to determine which candidate characteristics are determinative of successful recruitment.

### CROSS-REFERENCE TO RELATED APPLICATIONS

This application is related to U.S. patent application Ser. No. 14/218,413 filed Mar. 18, 2014 entitled “Business Audience Marketing System”; and this application is related to U.S. patent application Ser. No. 14/294,992 filed Jun. 3, 2014 entitled “Dynamic Advertisement Pricing System”, the entire content of which is incorporated by this reference for all purposes as if fully disclosed herein.

### FIELD OF THE DISCLOSURE

The present disclosure relates to targeting content to online users and, more specifically, to automatically nurturing potential candidates.

### BACKGROUND

Employers with hiring needs use one of two approaches to identify qualified candidates. In one approach, employers rely on recruiting agencies to identify candidates and notify the candidates directly through email, phone, mail, or other direct means. This approach is used for candidates with valuable but specialized skills or training. However, such an approach is labor intensive and expensive.

In another approach, employers post job listings on electronic job search sites that many people visit. While not exclusively used for this purpose, this approach is generally used for job positions that do not require specialized skills or for which there exists a large pool of potential candidates. This approach, although less expensive than the first approach, does not meet the needs of employers seeking more specialized talent.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts an example system for targeting content to candidates for one or more job openings, in an embodiment;

FIG. 2 is a block diagram that depicts multiple components of a targeted content system, in an embodiment;

FIG. 3 is a block diagram that depicts example nurture flows, in an embodiment;

FIG. 4 is a flow diagram that depicts an example process for automatically targeting content to a user, in an embodiment;

FIG. 5 is a block diagram that depicts a process for generating, training, and using a model for identifying potential candidates, in an embodiment;

FIG. 6 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Techniques are provided for automatically recruiting candidates for one or more job openings. The candidates may be identified based on a search of a database of user profile information that has been provided by multiple users. Recruiting-related content is then sent to the candidates in a systematic way. The recruiting-related content may be intended to educate the candidates about an employer or organization and/or to show benefits that may be derived from accepting a job position with the organization.

In an embodiment, a recruiting agent submits a query to identify candidates that satisfy one or more criteria, such as academic background and certain skills A system processes the query and identifies the appropriate candidates. The system assigns the candidates to a nurture flow that includes multiple segments, each segment corresponding to a different step in a recruiting plan. The segment to which a candidate is assigned dictates the content and, optionally, the delivery channel through which the content will be presented to the candidate. As a candidate is assigned to successive segments in a nurture flow, which additional content and how the additional content will be delivered may change. The nurture flow is designed to direct or focus a candidate toward accepting a job offer or learning more about a potential employer.

### System Overview

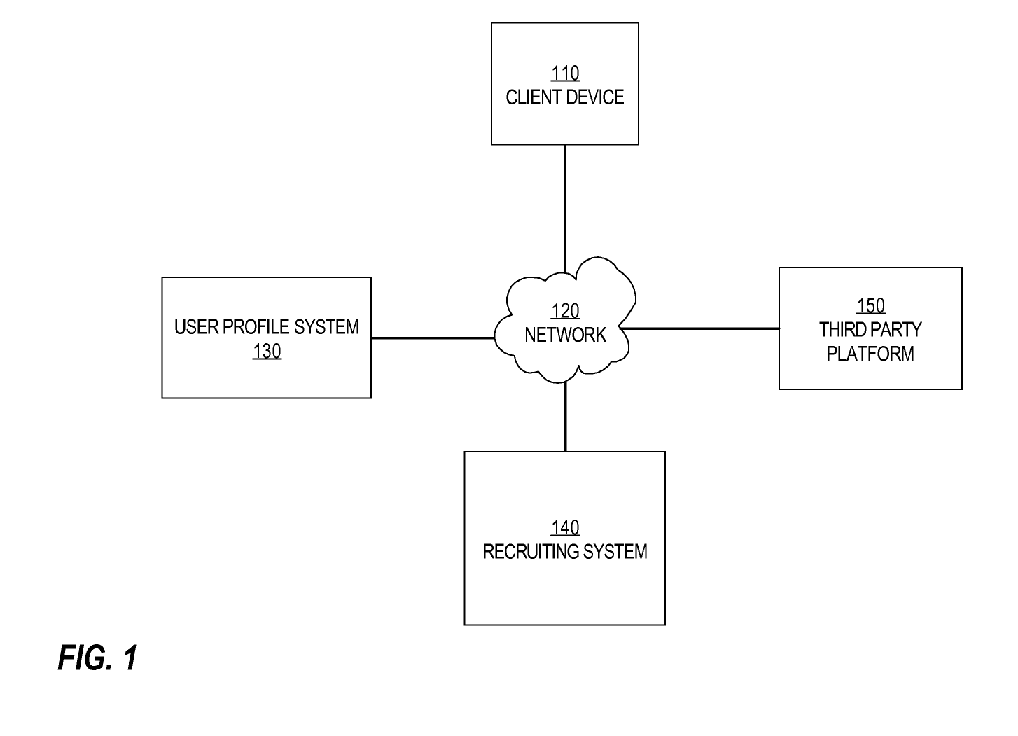

FIG. 1 is a block diagram that depicts an example system 100 for targeting content to candidates for one or more job openings, in an embodiment. System 100 includes a client device 110, a network 120, a user profile system 130, a recruiting system 140, and a third party platform 150.

Client device 110 is any computing device that is configured to communicate with web server system 130 over network 120. Examples of client device 110 include desktop computers, laptop computers, tablet computers, and smartphones. Client device 110 may execute multiple applications, such as web browsers and applications that are configured to communicate with a dedicated set of servers. Although only a single client device 110 is depicted, system 100 may include many client devices, each of which is configured to interact with user profile system 130 or third party platform 150.

Network 120 may be implemented on any medium or mechanism that provides for the exchange of data between client device 110 and user profile system 130. Examples of network 120 include, without limitation, a network such as a Local Area Network (LAN), Wide Area Network (WAN), Ethernet or the Internet, or one or more terrestrial, satellite or wireless links.

Each of user profile system 130, recruiting system 140, and third party platform 150 may be implemented in hardware, software, or a combination of hardware and software. Each of these components in system 100 may be implemented on a single computing device or multiple networked computing devices. Such a computing device may rely on third party services to perform certain functions, such as a storage service.

### User Profile System

User profile system 130 stores profile information of multiple users. User profile system 130 may be part of a social network system, such as one provided by LinkedIn, Google+, or Facebook.

A candidate's profile may include a first name, last name, an email address, residence information, a mailing address, a phone number, one or more educational institutions attended, one or more current and/or previous employers, one or more current and/or previous job titles, a list of skills, a list of endorsements, and/or names or identities of friends, contacts, connections of the user, and derived data that is based on actions that the candidate has taken. Examples of such actions include jobs to which the candidates has applied, views of job postings, views of company pages, private messages between the candidate and other users of the candidate's social network, and public messages that the candidate posted and that are visible to users outside of the candidate's social network.

Some data within a candidate's profile (e.g., work history) may be provided by the candidate while other data within the candidate's profile (e g, skills and endorsement) may be provided by a third party, such as a “friend” or connection of the candidate or a colleague of the candidate.

In an embodiment, user profile system 130 stores access data in association with a candidate's profile. Access data indicates which users, groups, or devices can access or view the candidate's profile or portions thereof. For example, first access data for a candidate's profile indicates that only the candidate's connections can view the candidate's personal interests, second access data indicates that confirmed recruiters can view the candidate's work history, and third access data indicates that anyone can view the candidate's endorsements and skills.

### Recruiting System

Recruiting system 140 is configured to identify candidates for one or more job positions and identify recruiting-related content to present to the candidates. Recruiting-related content may be text, graphics, images, video, or audio. Recruiting-related content may vary in the amount of detail and in the level of granularity. For example, one piece of recruiting-related content may include information about a particular company, such as what the particular company produces and who the customers of the particular company are. Another piece of recruiting-related content may include information about benefits of working at the particular company. Another piece of recruiting-related content may include information about a specific job opening at the particular company.

In an embodiment, recruiting-related content is dynamically assembled based on a repository of content assets that an employer has already shared or uploaded. The employer may have registered with an entity that owns or manages recruiting system 140. For example, a company may have authorized a company page to be created and hosted by a social network service. The company page provides information about the company. Examples of content assets that an employer has already shared or uploaded include a career page and Slideshare content from the employer. Recruiting system 140 automatically selects one or more of the already-uploaded content assets to use as part of a nurture flow (which is described in more detail below). In this way, employers are not required to provide additional recruiting-related content in order to target and nurture candidates toward recruitment.

Recruiting system 140 may be owned or operated by the same or different entity that owns or operates user profile system 130. For example, a social network provider may provide both user profile system 130 and recruiting system 140. Thus, user profile system 130 and recruiting system 140 may reside in the same network or even on the same computing device(s). As another example, a social network provider may provide user profile system 130 and a recruiting service may provide recruiting system 140.

As another example, a recruiting service may provide both user profile system 130 and recruiting system 140. In this example, users express their interest in being notified about potential job opportunities by registering with the recruiting service and uploading job-related information to the recruiting service. Furthermore, there may be no notion of a social network of “friends” or connections among the users that register with the recruiting service.

In an embodiment, a candidate's profile is associated with target indication data that indicates whether the candidate is to receive recruiting-related content about one or more job opportunities or organizations. A default setting for target indication data may be that the corresponding candidate is to receive recruiting-related content. The candidate may later change the setting to indicate that the candidate is to not receive recruiting-related content. In this way, a candidate must affirmatively opt out of receiving recruiting-related content. Alternatively, a default setting for target indication data may be that the corresponding candidate is not to receive recruiting-related content. The candidate may later change the setting to indicate that the candidate is to receive recruiting-related content. In this way, a candidate must affirmatively opt in to receiving recruiting-related content.

### Identifying Candidates

Recruiting system 140 receives one or more search criteria and identifies a set of one or more candidates that satisfy the one or more search criteria. The search criteria may be provided by a recruiter that contracts with a third-party employer to identify candidates for the employer. Alternatively, the recruiter may be “in-house”; or, an employee of the employer that is seeking qualified candidates. In this scenario, the recruiter may have other duties that are not related to recruiting.

Recruiting system 140 may comprise a web server that a client device connects to and that sends, to the client device, web content that a web browser processes to render a web page on a screen of the client device. The web page allows a user to enter or otherwise submit the one or more search criteria, which the client device sends to recruiting system 140. Alternatively, the client device executes a dedicated application provided by an owner or operator of recruiting system 140 and the dedicated application is configured to display a user interface that accepts the search criteria, connect with recruiting system 140, and send the search criteria to recruiting system 140.

Examples of search criteria include one or more academic degrees, one or more academic institutions, one or more previous or current employers, one or more skills, one or more geographical locations or regions (such as a specific city, state, or country, or a region of a country), one or more references, and/or one or more hobbies.

Recruiting system 140 sends the one or more search criteria to user profile system 130, which compares the one or more search criteria to profile data within profiles accessible to user profile system 130. A request to identify candidates (whether from the client device that initiated the request or from recruiting system 140) may include non-job-related filter data that is used to limit the number of candidates that are identified during a single search. Examples of filter data include an upper threshold indicating a maximum number of candidates to identify, a lower threshold indicating a minimum number of candidates to identify, and a strength threshold that indicates how strong a profile matches the search criteria.

The strength of a match between search criteria and a user's profile may be determined based on the number of search criteria that match a profile data item. For example, if a search includes four search criteria and three match a user's profile, then the strength of the match is 75%. As another example, some search criteria may be weighted higher than other search criteria in a single search. For example, a match of a user's academic degree to a search criterion may be weighted higher than a match of the user's current residence to a search criterion.

In an embodiment, information about the set of users that are identified based on a search (referred to herein as “candidates”) is displayed, for example, on a screen of the client device that submitted the search criteria. In this way, a user of the client device may be allowed to view profile information of each candidate and/or a strength indicator of each candidate.

In an embodiment, a search is automatically performed (i.e., repeated) to identify additional candidates whose profile information was not reflected in user profile system 130 or whose profile information did not match a previous search with the same search criteria. The search may be repeated periodically (e.g., every 24 hours or every week) or based on detection of certain events, such as a threshold number of candidates (a) not being identified for the initial search or (b) not progressing far enough in a nurture flow (described in more detail below).

### Storing Matches

In an embodiment, recruiting system 140 stores a record for each candidate that matches the one or more search criteria. Recruiting system 140 may store the records separately from the user profile information stored by user profile system 130. For example, recruiting system 140 may comprise a record database that is separate from the user profiles that user profile system 130 stores.

Embodiments are not limited to how records are stored or organized. The records may be organized based on the entity (e.g., third-party recruiter) that initiated the search and/or based on the search that was used to identify the records. For example, records of candidates that were identified using a first search are stored in a first table and records of candidates that were identified using a second search are stored in a second table. Both tables may be stored in associated with metadata that identifies the entities that initiated the respective searches.

In an embodiment, after a record of matching candidate is created and stored, the record is later updated. For example, if a candidate's profile in user profile system 130 is updated, then the candidate's profile (or just the updated information) is automatically sent to recruiting system 140. Specifically, if a candidate changes residence, changes employer, changes job title, adds a skill, is endorsed by another connection, earns another academic degree, enrolls at a university, changes employment status, etc., then user profile system 130 sends the new or updated information to recruiting system 140. In a related example, user profile system 130 periodically sends, to recruiting system 140, a batch of updated records, such as every 24 hours. In a related example, user profile system 130 determines to send a batch of updated records based on one or more different criteria, such as every 10^{th} updated record.

Additionally or alternatively, recruiting system 140 may operate under a pull model where recruiting system 140 requests updated records from user profile system 130. The frequency of such requests may be constant (e.g., every day) or vary based on certain criteria, such as the size of previous batches from user profile system 130. For example, if, after requesting batches every day where the batches averaged ten records, the latest batch included information about one hundred records, then user profile system 130 may begin requesting batches every twelve hours.

In an embodiment, recruiting system 140 stores, in association with different sets of records, access data that indicates which users, groups, or devices can access a particular set of candidate records. For example, if recruiting system 140 receives (1) first records based on a search initiated by a first recruiter and (2) second records based on a search initiated by a second recruiter, then recruiting system 140 associates (3) the first records with data that indicates the first recruiter and (4) the second records with data that indicates the second recruiter. Thereafter, only users or client devices associated with the first recruiter may access the first records and only users or client devices associated with the second recruiter may access the second records.

Additionally or alternatively, access data indicates how candidate records may be accessed, such as read privileges, delete privileges, insert privileges, and update privileges. For example, a recruiter may be allowed to update records, such as deleting data items (e.g., a non-working phone number indicated in a candidate record), adding data items (e.g., a work address), or changing data items (e.g., years worked at a particular company).

### Nuture Flows

After a set of candidates is identified based on a search, recruiting system 140 assigns each candidate to one or more nurture flows. A nurture flow is a recruiting plan for targeting content to a set of one or more candidates. A nurture flow is divided into progressive segments (or steps) that funnel a candidate toward performing a particular action, referred to herein as the “intended action.” Examples of an intended action include a candidate accepting a job opening associated with the search that identified the candidate, accepting a personal call from a recruiter, submitting a resume to recruiting system 140, visiting a particular web page or web site, viewing certain video content, and listening to certain audio content.

In an embodiment, one or more successive segments in a nurture flow represent an increase in intensity with which a user is targeted recruiting-related content. For example, while assigned to a first segment of a nurture flow, a user is sent a first advertisement about a particular organization. After being assigned to a second segment of the nurture flow, the user is sent two advertisements about the particular organization, which may be the same as or different than the first advertisement. Additionally, one or both of the advertisements may be sent through different channels (e.g., a social network provider, ad platform, etc.) than the channel through which the first advertisement was delivered (e.g., email).

Recruiting system 140 may manage multiple nurture flows. Each nurture flow may be associated with a particular entity or organization, such as an employer. In this embodiment, multiple entities may interact with recruiting system 140 to establish nurture flows and assign appropriate candidates to each nurture flow.

A user may be assigned to multiple nurture flows at the same time, but, in an embodiment, is not associated with more than one segment in a single nurture flow at the same time. If a candidate is assigned to two nurture flows and the two nurture flows were created for (or initiated by) different employers, then that indicates that multiple employers may be interested in attracting the same candidate.

In a related embodiment, a single entity (e.g., employer) initiates the creation of multiple nurture flows, where each nurture flow is associated with a different position or role within the employer. Thus, each nurture flow is designed for a different set of candidates. If a candidate is assigned to each of the nurture flows, then that indicates that the candidate satisfies (at least partially) the search criteria associated with each nurture flow.

In a related embodiment, a single entity initiates the creation of multiple nurture flows, where each nurture flow is associated with the same set of candidates. Each candidate may be initially assigned to a first nurture flow and later may be assigned to a second nurture flow if, for example, the candidate does not perform the intended action of the first nurture flow. Alternatively, different groups of candidates are assigned to each nurture flow. For example, based on a single search (or multiple searches using the same search criteria), a set of candidates. A first subset of the set of candidates is assigned to a first nurture flow, a second subset of the set of candidates is assigned to a second nurture flow, and so forth. In this example, the assignment of a candidate to a nurture flow may be performed randomly. Alternatively, the assignment may be based on the strength of a match of the candidate's profile to the corresponding search criteria. For example, candidates associated with higher strength matches are assigned to one nurture flow and candidates associated with lower strength matches are assigned to another nurture flow.

As noted previously, the segment to which a candidate is currently assigned may dictate which recruiting-related content will be delivered to the candidate. The recruiting-related content may be provided by a recruiter or employer at the time of the corresponding nurture flow is created. Additionally or alternatively, recruiting-related content that is delivered to candidates that are assigned to a segment may have originated from the employer long prior to the creation of the nurture flow. As noted previously, recruiting system 140 may automatically select content assets (such as a career page or a SlideShare presentation) that were previously shared or uploaded by an employer. Recruiting system 140 may dynamically select one or more of the already-uploaded content assets to use when it is determined that a candidate is to receive recruiting-related content. Additionally or alternatively, recruiting system 140 associates such content assets with one or more segments of a nurture flow prior to a determination that a candidate assigned to one of the segments is to receive recruiting-related content, such as during creating of the nurture flow.

### Nurture Flow Assignment Criteria

If an entity (e.g., an employer) is associated with multiple nurture flows, then recruiting system 140 determines to which nurture flow a candidate should be assigned. Recruiting system 140 analyzes a candidate's profile and one or more “nurture flow assignment criteria” associated with each of multiple nurture flows to determine to which of the multiple nurture flows the candidate is to be assigned. An example of a nurture flow assignment criterion is an entity identifier and/or nurture flow identifier. For example, a result of a search may indicate a particular employer and/or a particular nurture flow. As a specific example, a candidate's profile may be supplemented to include a particular entity identifier that identifies the particular entity that initiated the search. Then, a user (e.g., of the client device that initiated the search) provides input that associates the candidate's profile with a particular nurture flow created by the particular entity. In this way, recruiting system 140 selects the appropriate nurture flow from the set of nurture flows associated with the entity identified by the particular entity identifier.

Another example of a nurture flow assignment criterion is a set of one or more attributes of a candidate. For example, recruiting system 140 may compare profile information of a candidate's profile with nurture flow assignment criteria associated with each nurture flow. A nurture flow assignment criterion may be the same as or different than one of the search criteria. As a specific example, if a candidate's profile indicates that the candidate is employed, then the candidate is assigned to a first nurture flow. If a candidate's profile indicates that the candidate is unemployed, then the user record is assigned to a second nurture flow that is different than the first nurture flow. If a candidate's profile indicates that the candidate is female, over 30 years of age, and lives in the Pacific Northwest, then the candidate is assigned to a third nurture flow. Thus, different nurture flows may be associated with different nurture flow assignment criteria. If nurture flow assignment criteria of multiple nurture flows are satisfied, then a matching nurture flow may be randomly selected or displayed to a user (e.g., of a client device that sent the corresponding search criteria) for manual assignment.

In addition to employment history or demographic information, another example of a user attribute is a candidate having performed a certain action (such as visiting a particular web page or web site or having worked for a particular employer in the past). Thus, different actions may be associated with different nurture flows.

Additionally or alternatively, recruiting system 140 may receive success data that indicates a likelihood of a candidate performing the intended action of each of multiple nurture flows, such as accepting an offer of employment through the recruiter whose search criteria identified the candidate. Such success data may be generated using a model that is based on a history of other candidates that are considered similar to the candidate and whether those candidates performed the intended action(s) of the nurture flow(s) to which they were assigned. The success data may be used to assign a candidate to a certain nurture flow if there are multiple nurture flows from which to select.

### Creating Nuture Flows

A recruiter may establish a nurture flow to be managed by recruiting system 140 in one of multiple ways. For example, a recruiter may define multiple (or all) attributes of a nurture flow using a user interface displayed, on a client device operated by the recruiter, by a web application provided by recruiting system 140. Example nurture flow attributes include a number of segments in the nurture flow, an intended action of the nurture flow, targeting parameters (described in more detail below) for each segment in the nurture flow, and segment advancement criteria (also described in more detail below) for each segment in the nurture flow.

As another example, a recruiter may select (e.g., using a user interface provided by recruiting system 140) a nurture flow from among multiple “default” nurture flows. The recruiter may then modify or customize the selected nurture flow according to the employer's needs, such as modifying a number of segments in the nurture flow, defining an intended action for the nurture flow, defining one or more targeting parameters, and/or defining segment advancement criteria.

### Targeting Parameters

A segment in a nurture flow is associated with one or more targeting parameters that influence how one or more entities (e.g., recruiting system 140 and/or third party platform 150) interact with client device 110 used by a candidate that is associated with that segment. For example, a targeting parameter may be to provide a particular advertisement when a request for an advertisement is received from client device 110 assigned to the associated segment. As another example, a targeting parameter may be to send an email message to an email account of the candidate, a text message to client device 110 (or another device operated by the candidate), or a message to an (e.g., “mobile”) application executing on client device 110 (or another device operated by the candidate). For purposes of brevity, although content may be targeted to other devices of a particular candidate, the following description involves sending recruiting-related content to client device 110.

A targeting parameter of a segment may indicate which entity is to perform an action associated with the segment. The entity may or may not be different than recruiting system 140. For example, in response to determining to target content to a user assigned to a segment, recruiting system 140 identifies a targeting parameter of the segment and, based on the targeting parameter, sends targeting instruction data to third party platform 150 (as opposed to another third party platform, not depicted). The targeting instruction data may identify client device 110 and include (or identify) particular content that third party platform 150 is to send to client device 110.

Examples of types of third party platform 150 that may be instructed to perform actions associated with a segment include social network providers (e.g., Facebook, LinkedIn, etc.), search engine providers, and ad providers. For example, a social network provider, based on targeting instruction data, may identify a user account and cause certain content to be displayed, to the user of the user account, in a news feed when the user is viewing web content (provided by the social network provider) in a dedicated application or in a web browser. As another example, an ad provider determines that a particular user is viewing a blog and causes an advertisement to be displayed on (or adjacent to) the blog. Such third party platforms are considered “content delivery channels” that are used to reach candidates that are assigned to segments in the nurture flow(s).

A targeting parameter may specify a particular content delivery channel to use to send content to a user. Additionally or alternatively, a targeting parameter may specify multiple content delivery channels and recruiting system 140 selects one of the channels based on one or more criteria, such as whether the user is reachable through the channel or has a history of being reached through the channel. For example, if it is known that a user has interacted with content delivered through channel A but there is no history of the user interacting with content delivered through channel B, then recruiting system 140 may select channel A over channel B. As another example, multiple channels may be ordered based on priority. If a user is not reachable through the top-most channel in terms of priority, then targeted content is sent to the user through the next highest ranked channel.

In an embodiment, the entity (e.g., recruiter) that initiates creation of a nurture flow selects targeting parameters when creating a nurture flow. Additionally or alternatively, other entities (e.g., an authorized user of recruiting system 140) may select targeting parameters of one or more segments.

In a related embodiment, a targeting parameter of a particular segment may be updated after a nurture flow is created and while candidates are currently assigned to the particular segment. For example, a targeting parameter of a segment may specify that a first channel is to be used to delivery first content to users assigned to the segment. Later, the targeting parameter is updated to specify a second channel (that is different than the first channel) is to be used to deliver the first (or different) content to candidates assigned to the segment.

If a segment is associated with multiple targeting parameters, then recruiting system 140 may process each targeting parameter simultaneously or relatively close together in time. Additionally or alternatively, recruiting system 140 may process the multiple targeting parameters of a segment in a particular order over a pre-defined period of time, such as a different targeting parameter each day.

A targeting parameter may be associated with a repeating indicator that indicates a number of times the targeting parameter should be processed. For example, a targeting parameter with a repeating indicator of three will be processed at most three times relative to a user that is assigned to the corresponding segment, unless the user advances to another segment (or another nurture flow) before the targeting parameter is processed the third time.

In an embodiment, as soon as a candidate is assigned to a segment in a nurture flow, recruiting system 140 immediately processes one or more targeting parameters associated with the segment. Alternatively, a targeting parameter may be associated with a waiting time before which recruiting system 140 processes the targeting parameter. For example, after a candidate advances from a first segment to a second segment in a nurture flow, recruiting system 140 waits ten hours before processing any targeting parameter associated with the second segment.

### Segment Advancement Criteria

In an embodiment, recruiting system 140 uses one or more criteria to determine whether to assign a user (that is already assigned to a particular segment in a nurture flow) to another segment in the nurture flow. Such criteria are referred to herein as “segment advancement criteria.”

Segment advancement criteria may be conditions that, when satisfied, cause a candidate to be advanced to the next segment in a nurture flow. An example of such a condition is whether the candidate has performed a particular action, such as viewed a particular video, listened to a particular podcast, purchased a particular item, visited a particular web site, or physically visited a particular geographic location/region (such as a country). Evidence of performance of the particular action may come from (1) third party platform 150 (e.g., that detects the candidate, or client device 110, selecting an advertisement that third party platform 150 displays to the candidate), (2) client device 110 (that executes an application that detects the candidate selecting a particular link), or (3) another source, not depicted in FIG. 1.

In a related example, a segment advancement criterion of a particular segment may be evidence that a candidate interacted with content that was targeted to the candidate based on a targeting parameter associated with the same segment. In other words, the condition that triggers the advancement of a candidate from a first segment to a second segment may be the candidate selecting an advertisement or viewing a video that is presented to the candidate according to a targeting parameter of the first segment.

Another example of a segment advancement criterion is the candidate or an entity (e.g., company/organization) associated with the candidate being named or otherwise identified in a news article. The candidate may be an employee of the employer (or a student of the university) identified in the news article, may run/own the organization/company, or may be a board member/officer of the organization/company. Such news data may come from a social network service (not depicted in FIG. 1) or another source. Thus, an entity may analyze news articles, alerts, and/or other content that is being published (e.g., even after the candidate is assigned to a segment in a nurture flow) and send that information to recruiting system 140.

Another example of a segment advancement criterion is the user having a new connection (in a social network) to another connection that satisfies one or more criteria. For example, if a recruiter is targeting a candidate and the candidate becomes friends with an officer of company associated with the recruiter (as reflected in the candidate's updated record, for example), then the candidate advances to a subsequent segment in a nurture flow. Such social network data may come from user profile system 130 or another source (not depicted).

Another example of a segment advancement criterion is the employment status of a candidate changing. For example, if it is detected that a candidate recently became unemployed, then the candidate is advanced to a subsequent segment (e.g., two or more segments away from the currently-assigned segment) in the nurture flow. As another example, if it is detected that a candidate recently changed jobs, then the candidate may be assigned to a previous (e.g., beginning) segment in the currently-assigned nurture flow, may be assigned to a different nurture flow, or may be removed from any nurture flow associated with the search that identified the candidate. Recruiting system 140 may detect the employment change when a candidate record maintained by recruiting system 140 is updated based on profile data received from user profile system 130.

Another example of a segment advancement condition is change in residence. For example, if a candidate moves to a city, state, or region that (a) was specified in search criteria that was used to identify the candidate or (b) is near an employer represented by a recruiter that is nurturing the candidate, then the candidate may be assigned to another segment in a nurture flow.

Another example of a segment advancement condition is time. For example, a candidate that is in a current segment of nurture flow may advance to a subsequent segment of the nurture flow after the lapse of a particular amount of time, such as three months. In a related example, a current segment may have multiple segment advancement criteria, only one of which is time-based. Thus, if the candidate does not advance to the subsequent segment in the nurture flow based on one or more other segment advancement criteria, then, after the particular amount of time, the time-based criterion is triggered and the candidate is advanced to the subsequent segment.

### Segment Advancement Criteria

### Measures of Influence

Additionally or alternatively, segment advancement criteria may be a measure of influence/engagement (also referred to as a “lead score”) or a range of measures of influence. A measure of influence is indicative of how likely a candidate is to perform the intended action associated with a nurture flow, such as visiting a particular web page, viewing an advertisement, downloading a video file, visiting a job fair, making a donation to a particular institution, or purchasing a product/service from a particular company.

In this embodiment, a candidate is associated with a measure of influence and, if the candidate's measure of influence increases above the segment advancement criterion associated with the segment to which the candidate is currently assigned, then the candidate is advanced to another segment in the nurture flow. For example, one or more segments in a nurture flow may be associated with one or more lead scores (or a range of lead scores) that measure the relative probability of a candidate to perform the intended action of the nurture flow. If a candidate's lead score increases to be outside the range of the segment to which the candidate is currently assigned, then the candidate is assigned to the next (immediately adjacent) segment in the nurture flow or to another segment in the nurture flow, effectively “skipping” one or more intermediate segments.

Because a nurture flow includes multiple segments, each segment within the same nurture flow may be associated with different set of one or more segment advancement criteria and different types of segment advancement criteria.

Similarly, user interaction with one content delivery channel may cause a candidate to advance one segment in a nurture flow while subsequent candidate interaction with another content delivery channel may cause the candidate to advance to another segment in the same nurture flow. For example, a candidate may click on an advertisement presented to the candidate through channel A, which causes the candidate to advance from a first segment to a second segment in a nurture flow. Later, the candidate selects a link in a pop-up window provided through channel B, which causes the candidate to advance from the second segment to a third segment in the nurture flow.

### Example Components of Recruiting System

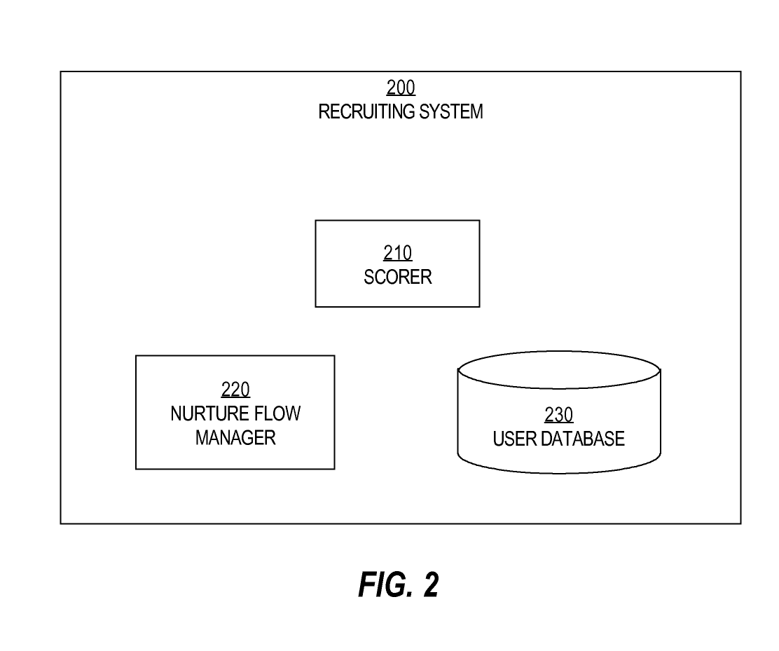

FIG. 2 is a block diagram that depicts multiple components of a recruiting system 200, which may be the same as recruiting system 140. Recruiting system 200 includes a scorer 210, a nurture flow manager 220, and a user database 230. Scorer 210 and nurture flow manager 220 may be software application modules executing on recruiting system 200. Other embodiments of recruiting system 200 may include more or fewer components than 210-230.

In an embodiment, scorer 210 determines a measure of influence of a candidate based, at least in part, on the characteristics of the candidate (and/or the candidate's connections), what actions the candidate has performed, and/or other criteria being satisfied. For example, scorer 210 may be responsible for analyzing profile data from user profile system 130. Additionally, scorer 210 updates the measure of influence (e.g., a lead score) for a candidate using information received from user profile system 130, a marketer (not depicted), third party platform 150, or some combination thereof.

Nurture flow manager 220 is configured to map (or assign) candidates (or their respective client devices) to certain nurture flows and, additionally, to specific segments within the nurture flows. Nurture flow manager 220 may take into account measures of influence (or lead scores) determined by scorer 210. Nurture flow manager 220 may assign a candidate to the first segment in a nurture flow when the candidate is first associated with the nurture flow. Additionally or alternatively, nurture flow manager 220 may assign a candidate to some other segment in a nurture flow based on information received from user profile system 130 or some other source, such as third party platform 150, or a marketer (not depicted).

Candidate database 230 stores candidate records. Embodiments are not limited to how candidate database 230 is implemented. Examples of candidate database 230 include a relational database, an object database, an object-relational database, a NoSQL database, or a file system. For example, each candidate record may be stored as a row in a table, where each table corresponds to a different nurture flow or a different entity that initiated creation of the nurture flow.

### Example Nurture Flows

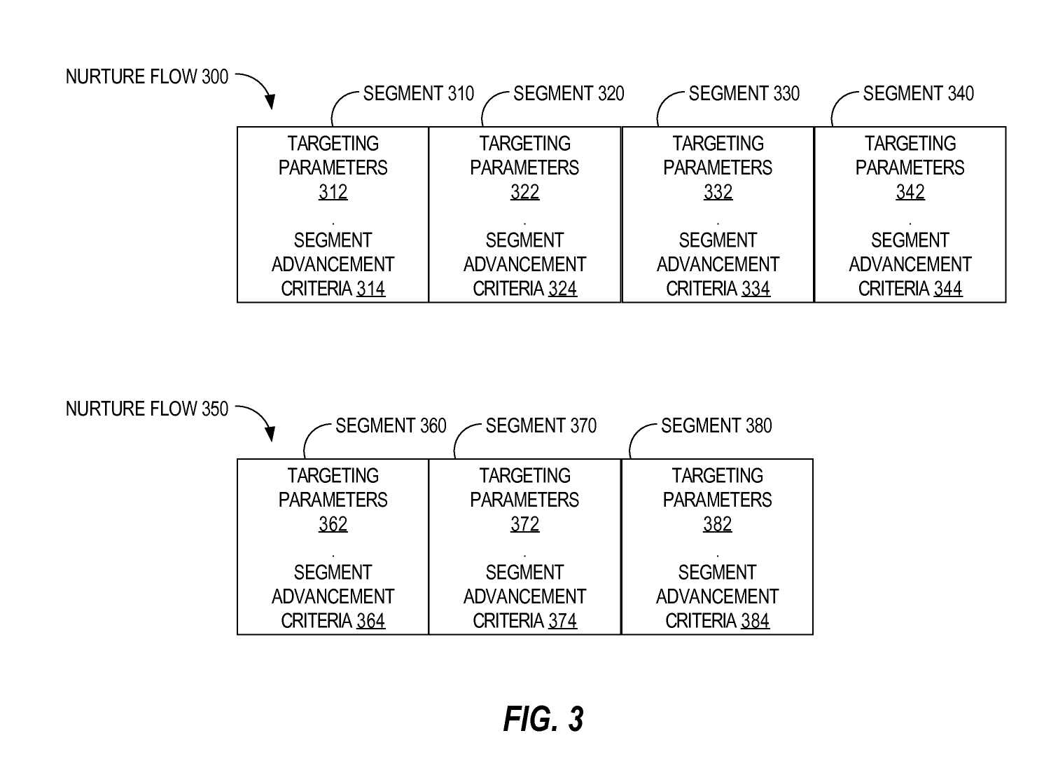

FIG. 3 is a block diagram that depicts example nurture flows 300 and 350, in an embodiment. As described previously, nurture flows 300 and 350 may be created based on user input that nurture flow manager 220 processes or may be created automatically. Also, nurture flows 300 and 350 may be created for the same entity or for different entities.

In the depicted example, nurture flow 300 includes four segments 310-340 while nurture flow 350 includes three segments 360-380. Segment 310 includes (or is associated with) targeting parameters 312 and segment advancement criteria 314; segment 320 includes targeting parameters 322 and segment advancement criteria 324; and so forth. However, segment 340 does not include segment advancement criteria. This may be the case if the candidate is not able to advance any further. Either the candidate performs an intended action associated with nurture flow 300 or not.

In contrast, the last segment in nurture flow 350 includes segment advancement criteria 384. Such criteria may indicate that a candidate that is assigned to segment 380 may be assigned to another nurture flow if, for example, the candidate did not perform an intended action associated with nurture flow 350. Thus, the candidate may continue to be nurtured, but perhaps in a different way and intensity, as reflected by the targeting parameters and segment advancement criteria of the other nurture flow.

While a candidate is assigned to segment 310, nurture flow manager 220 processes targeting parameters 312 to determine what content will be delivered to the candidate, how the content will be delivered (such as which delivery channel to use), and, optionally, when the content will be delivered. Nurture flow manager 220 also processes segment advancement criteria 314 to determine whether to advance the candidate to segment 320 (or to another segment in nurture flow 300).

Nurture flow manager 220 similarly processes targeting parameters 362 for candidates that are assigned to segment 360 of nurture flow 350 and processes segment advancement criteria 364 to determine whether to advance the candidate to segment 370 or segment 380 in nurture flow 350.

### Example Process

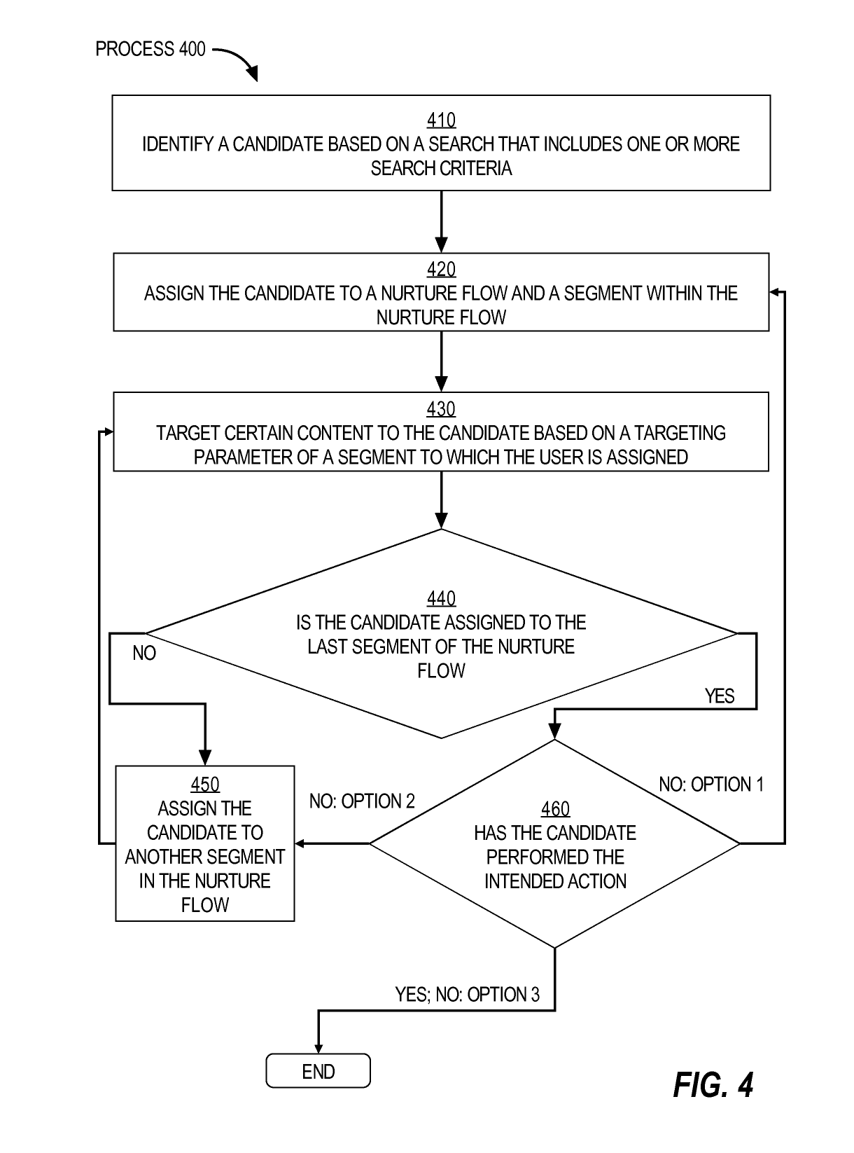

FIG. 4 is a flow diagram that depicts an example process 400 for automatically targeting content to a candidate, in an embodiment. Process 400 may be implemented by recruiting system 140.

At block 410, a candidate is identified based on a search that includes one or more search criteria. The search may have been initiated by a third-party recruiter that leverages recruiting system 140 to target candidates for one or more positions at one or more employers. The candidate may be part of multiple candidates that are identified based on the search.

At block 420, the candidate is assigned to a nurture flow. Block 420 may involve recruiting system 140 receiving the candidate's profile from user profile system 130 and selecting a nurture flow (if more than one exists) to which the candidate is to be assigned. The nurture flow may be selected from among a plurality of possible nurture flows and/or based on comparing at least some of the candidate's profile data with nurture flow assignment criteria associated with each of multiple nurture flows. Initially, the candidate may be assigned to the first segment in the nurture flow.

At block 430, certain content is targeted to the candidate based on the targeting parameter(s) of the segment to which the candidate is assigned. Block 430 may involve nurture flow manager 220 identifying particular content and a channel through which the particular content will be delivered to the candidate. Nurture flow manager 220 sends the particular content and a device or candidate identifier to the channel (or to, for example, third party platform 150), which is responsible for presenting the particular content to the candidate.

At block 440, it is determined whether the candidate is in the last segment in the nurture flow. If not, then process 400 proceeds to block 450. Else, process 400 proceeds to block 460.

At block 450, it is determined that the candidate satisfies one or more segment advancement criteria and assigns the candidate to a subsequent segment in the nurture flow. Block 450 may be performed by nurture flow manager 220. Process 400 proceeds to block 460.

At block 460, it is determined whether the candidate performed the intended action (e.g., accepted a phone call from a recruiter) associated with the nurture flow. If so, then process 400 ends. Else, process 400 may proceed to block 420 where the user is assigned to another nurture flow, which may be designed for candidates that did not perform the intended action. Alternatively, process 400 may proceed to block 450 where the candidate is assigned to another (i.e., previous) segment in the nurture flow. Additionally or alternatively, process 400 may end after two or more iterations of block 460 for the particular candidate.

Although process 400 is depicted and described as being performed in a particular order, process 400 may be performed in a different order. For example, the determination of whether a candidate has performed the intended action associated with a nurture flow (block 460) may be performed before determining whether the candidate is assigned to the last segment in a nurture flow (block 440).

### Benefits of Various Techniques

Techniques described above for automatically targeting content to candidates may provide one or more benefits. One benefit is that a candidate who qualifies for a job opening can be automatically targeted (or “nurtured”) in a systematic way. One possible benefit is that content can be automatically targeted to a candidate through multiple channels to encourage the candidate to perform the intended action (or one or more actions that are indicative of the candidate's interest in an organization). Another possible benefit is that content can be targeted to multiple of devices of a candidate.

### Collecting Additional User Data

In an embodiment, information about the activity of candidates is collected. The information may be collected by one or more third party platforms (e.g., third party platform 150), recruiting system 140, user profile system 130 or a combination thereof. The activity of candidates may pertain to what actions the candidates performed while the candidates were assigned to certain nurture flows or certain segments. For example, in response to receiving targeting instruction data from recruiting system 140, third party platform 150 causes a particular link to a video (or advertisement) to be displayed to a candidate (e.g., through client device 110). Third party platform 150 determines that the candidate selects the particular link and sends, to recruiting system 140, a message reporting about the selection, such as an identity of the candidate (and/or client device 110), what content was selected, when the selection occurred (e.g., time of day, day of week, month, year), what browser or application the candidate used to perform the selection, and/or where the candidate (or client device 110) was located (e.g., geographically) at the time of the selection. Recruiting system 140 associates the data in the message with the candidate and/or with the nurture flow and segment responsible for the targeting instruction data.

As another example, a user profile record in user profile system 130 is updated to indicate that the corresponding candidate performed a certain action or that something of significance happened to the candidate. Such an action may be agreeing to a lunch meeting with a recruiter (or a member of a particular company/organization), visiting a particular warehouse owned by the organization, attending a trade show, attending an online seminar, completed a telephone call, etc.

Other information that may be collected about a candidate may include relevant events that occurred in a social network in which the candidate is a member or events that are reported in social media or elsewhere on the World Wide Web. For example, immediately prior to a candidate being assigned to a nurture flow, the candidate changed employers, changed roles within her company, or increased the number of connections in an online social network to which s/he belongs by twenty connections or 10%.

Information that is collected about a candidate may include timing and/or sequence information. For example, a candidate changed jobs at time 1, filled out a form on a web page at time 2, was presented targeted content (according to a nurture flow) on channel Z at time 3, increases the number of his connections by over 10% between time 3 and time 4 (which is less than three days), and performed an intended action (associated with the nurture flow) at time 5. The timing and sequence of events that led to the candidate performing the intended action may be used, in conjunction with similar data regarding other candidates who performed their respective intended actions, to predict (as described in more detail below) what other candidates should be targeted, even users who are not currently represented in recruiting system 140 (as described in more detail below).

### Nurture Flow Reports

In an embodiment, information about candidates' progress through nurture flows is tracked. A nurture flow may be associated with a success rate, which indicates a number (or percentage) of candidates that were assigned to the nurture flow and also performed the intended action. For example, an entity creates three nurture flows with the same intended action. Recruiting system 140 determines that 50% of candidate assigned to Nurture Flow A perform the intended action, 25% of candidates assigned to Nurture Flow B perform the intended action, and 5% of candidates assigned to Nurture Flow C perform the intended action. Recruiting system 140 may generate a report that indicates the success rate of each nurture flow, which allows entities (e.g., recruiters that established the nurture flows) to determine which nurture flows are most effective.

As another example, recruiting system 140 tracks how many candidates assigned to a nurture flow progress to subsequent segments in the nurture flow. For example, 80% of candidates in the first segment of a nurture flow advance to the second segment in the nurture flow, while only 30% of candidates assigned to the second segment advance to the third segment in the nurture flow, while 50% of candidates assigned to the third segment advance to the fourth segment in the nurture flow. Thus, the first segment has an “advancement rate” of 80%, the second segment has an advancement rate of 30%, and the third segment has an advancement rate of 50%.

In addition to a nurture flow's success rate and a segment's advancement rate, a report may indicate one or more of the following pieces of information: an indication of which delivery channels were used in each segment, an average or median amount of time candidates were assigned to a nurture flow, an average or median amount of time candidates were assigned to a particular segment, a segment's advancement rate when a particular delivery channel was used (e.g., relative to when another delivery channel was used for that same segment), a (e.g., percent) change in a segment's advancement rate before and after a change in a targeting parameter (e.g., a different delivery channel was used), a (e.g., percent) change in a segment's advancement rate before and after a change in segment advancement criteria, a (e.g., percent) change in a segment's advancement rate before and after a change in timing of when a targeting parameter is processed.

A report may also indicate characteristics or attributes of candidates that (1) performed an intended action of a nurture flow, (2) did not perform the intended, (3) advanced from a particular segment, and/or (4) did not advance from a particular stage. For example, 80% of candidates that accepted a phone call from a recruiter had an advanced degree. As another example, 95% of candidates that did not advance from a first segment to a second segment in a nurture flow have been with their currently employer for less than one year.

In an embodiment, recruiting system 140 automatically generates one or more reports regarding a nurture flow. A report may be generated when certain criteria (referred to as “report generation criteria”) are satisfied, such as a nurture flow's success rate being under 5% for two consecutive days or the advancement rate of a segment dipping below 20% after one week of the nurture flows creation. “Report generation criteria” for a nurture flow may be default criteria (i.e., established by recruiting system 140) or may be provided (or at least selected) by the entity (e.g., recruiter) that initiated creation of the corresponding nurture flow.

Based on report information, an entity may instruct recruiting system 140 to delete one or more (e.g., “poor” performing) nurture flows, modify an existing nurture flow (such as changing a channel associated with a segment or changing a segment advancement criterion of a particular segment), or add one or more new nurture flows.

In an embodiment, an entity creates a set of nurture flows that differ significantly from each other and instructs recruiting system 140 to randomly assign candidates to one of the nurture flows in the set. In this way, the entity may determine which nurture flow in the set is performing the best. The entity may then delete the poorer performing nurture flows and create additional nurture flows that differ less significantly from the best nurture flow. This process may repeat any number of times. In this way, the entity may come to identify a nurture flow that performs better than, not only the initial “best” nurture flow, but also other nurture flows that were considered “best” in rounds subsequent to the initial round.

### Recruiter Intervention

In an embodiment, a recruiter uses information about a candidate's progress to determine whether or when to contact the candidate. For example, a recruiter may choose to contact a candidate that reaches a particular segment within a nurture flow through a personal email. As another example, a recruiter may choose to call a candidate that reaches a different segment within the nurture flow. A recruiter may be informed about a candidate's progress by viewing a nurture flow report. Alternatively, a recruiter may be notified (e.g., via email, text message, or mobile app notification) that a candidate has reached a particular segment or performed a particular action, such as visiting a job postings page of the corresponding employer. A link in the message or notification may cause a display to be generated that includes information about the candidate, such as contact information and/or online behavior information of the candidate.

A recruiter may desire to know how candidates associated with a nurture flow are doing after a period of time has lapsed since the nurture flow was created or since the first candidates were assigned to the nurture flow. For example, a recruiter may provide input that indicates that the recruiter desires to be notified in four months from the creation of a nurture flow. The recruiter may then request information about candidates that have reached the latest segment in the nurture flow. The candidates assigned to the nurture flow may be sorted based on segment assignment or not shown at all if the candidates have not reached, for example, the second segment. As another example, a recruiter may provide input that indicates that the recruiter desires to be notified for each candidate that reaches a particular segment within three months from when the candidate was assigned to the nurture flow. The recruiter may then request information about the candidate to determine whether to individually contact the candidate.

### Integration with a Recruiter Tool

One or more techniques described herein are integrated with an existing recruiter tool that allows recruiters to send (e.g., individualized) messages to candidates. The recruiter tool provides a user interface that allows a recruiter to search for potential recruits and send messages to the potential recruits. The recruiter tool may be a web-based tool or a client-based tool that interacts with a server over a network to obtain up-to-date information.

In one approach, the recruiter tool is updated to include a user interface that allows a recruiter to create a nurture flow, such as allowing the recruiter to specify a number of segments for the nurture flow, one or more target parameters for each segment (including one or more delivery channels for each segment and/or one or more creatives for each segment), and segment advancement criteria for each segment. The user interface may indicate that a segment or nurture flow is associated with one or more default settings, such as a particular delivery channel, a template for inserting recruiting-related content for a creative (e.g., advertisement).

In another approach, the recruiter tool is notified when an event associated with a candidate occurs. Example events include the candidate performing an intended action of a nurture flow to which the candidate is assigned, the candidate being advanced to a particular segment in a nurture flow, the candidate performing a particular action (e.g., visiting a particular web page or viewing certain content), the candidate changing employment status, the candidate being connected to a particular person at an organization associated with the recruiter (e.g., the recruiter's company), the candidate connecting to a certain number of users in the last week hours, the candidate changing a certain number of profile elements in the candidates' social user profile, and the candidate changing a certain set or combination of profile elements. One or more of these events may indicate that it is a good time for the recruiter to contact the candidate or to at least monitor the candidate more closely.

The recruiter tool may or may not distinguish between different types of events. For example, the recruiter tool may treat all events the same by, for example, causing an event indicator to be displayed on a user interface of the tool or sending a message to a recruiter, regardless of the type of event. Alternatively, the recruiter tool performs different actions depending on the type of event. For example, one type of event (e.g., advancement from one segment to another) may cause the recruiter tool to display an event indicator when the recruiter logs into the recruiter tool and another type of event (e.g., change in employment status to unemployed) may cause the recruiter tool to send a text message to the recruiter to ensure that the recruiter can act on the information immediately. In an embodiment, the recruiter tool allows a recruiter to select certain actions based on certain types of events occurring.

### Nurture Flow Change Recommendations

In an embodiment, recruiting system 140 recommends one or more changes to make to a nurture flow or set of nurture flows established by a particular entity. The recommendations may accompany a nurture flow report and may be based on information tracked for the nurture flow. For example, recruiting system 140 recommends that segment advancement criteria of a particular segment be relaxed due to a low advancement rate associated with the particular segment. As another example, recruiting system 140 recommends that the amount of time that elapses before a targeting parameter of a particular segment is processed should be increased by one day.

A recommendation may also be based on information collected regarding one or more other nurture flows, even nurture flows that were established by other entities (e.g., recruiters). For example, recruiting system 140 recommends that a delivery channel be used for a particular segment based on that delivery channel's success with respect to other nurture flows.

### Automatically Modifying Nurture Flows

In an embodiment, recruiting system 140 is configured to automatically delete or modify a nurture flow. For example, if less than 5% of candidates assigned to a particular nurture flow are performing the intended action after being assigned to the particular nurture flow for a particular period of time (e.g., seven months), then the particular nurture flow is deleted. The deletion may be predicated on there being one or more other nurture flows (established for the same entity as the deleted nurture flow) to which future candidates may be assigned.

As another example, recruiting system 140 determines that third party platform 150 (or another delivery channel) indicated in a particular segment of a nurture flow is offline or otherwise not responsive. In response, recruiting system 140 selects a different third party platform or delivery channel for the particular segment. As another example, recruiting system 140 determines that less than 15% of candidates assigned to a particular segment in a nurture flow are advancing to a subsequent segment in the nurture flow. In response, recruiting system 140 (a) notifies the “owner” of the nurture flow (or nurture flow creator) and, optionally, suggests a modification to the nurture flow or (b) relaxes the segment advancement criteria associated with the particular segment such that it is easier for candidates to advance to subsequent segments in the nurture flow.

In a related embodiment, recruiting system 140 is configured to create a new nurture flow. A new nurture flow for a particular entity may be based on one or more other nurture flows established by or for the particular entity. For example, an entity creates two nurture flows that are similar except for the second and fourth segments. Recruiting system 140 determines that a first nurture flow is advancing candidates from the second segment at a higher rate than the second nurture flow, but that the second nurture flow is advancing candidates from the fourth segment at a higher rate than the first nurture flow. In response, recruiting system 140 creates a third nurture flow that is identical to the first nurture flow, except that the fourth segment in the third nurture flow uses the targeting parameters of the fourth segment in the second nurture flow.

A new nurture flow may be initially “active.” An “active” nurture flow is one to which candidates may be assigned. Conversely, an “inactive” nurture flow is one to which candidates may not be assigned without explicit input. For example, a new nurture flow is initially inactive and the entity that is associated with the nurture flow (or representative thereof) is notified of the new nurture flow. A notification may come through any notification channel, such as an email message, an IM, an automated telephone call, or a display message when the entity logs into recruiting system 140 to manage the entity's nurture flow(s). The entity must then provide explicit input (e.g., checking a box, or selecting a URL in a body of an email) to activate the new nurture flow.

### Predicting Future Candidates

The search criteria of a search for candidates may be too narrow in that too few candidates are identified or at least the search does not identify users who might be good candidates to recruit but do not otherwise satisfy all (or much) of the search criteria.

In an embodiment, users who have not been identified as a result of a search, such as one initiated by a recruiter, are identified as candidates associated with the search. Such users are referred to herein as “potential candidates.” Thus, a potential candidate may be similarly targeted (or at least identified) using recruiting system 140. The targeting of a potential candidate (a) may occur immediately once the potential candidate is identified or (b) may be delayed until one or more criteria are satisfied, such as criteria that indicate that the potential candidate may be more receptive to responding favorably to recruiting-related content.

As described previously, user profile system 130 and recruiting system 140 may be implemented on the same platform or at least be owned/operated by the same entity. Thus, recruiting system 140 may have access to the same data that user profile system 140 does. For example, recruiting system 140 may have access to profile data of users that have registered with one or more online social networks.

### Comparing User Profiles

In an embodiment, profiles of candidates who performed an intended action associated with a nurture flow (referred to herein as “successful candidates”) are compared to user profiles in user profile system 130 or in a social network to identify one or more matching profiles. A “matching” profile is not necessarily an exact match. For example, two profiles may match even though the corresponding users reside in very geographically different locales.

A user profile (whether of a candidate or of a potential candidate) includes information about the user, such as gender, age, ethnicity, income level, country/state/city of residence, current and previous employers, current and previous job titles, current and previous industries, academic institutions attended, job status, organizations in which the user is a member, skills, number and identity of connections, recommendations from connections, sports interests, entertainment interests, and/or hobbies.

A user profile may also include event information, such as the user (or the user's employer) being mentioned in a news article or blog. Event information for a particular event may indicate when the particular event occurred. Such timing information may be used when identifying a matching profile. For example, if 80% of successful candidates of a nurture flow updated their user profiles in one or more social networks within five days of being assigned to the nurture flow, then the fact that a potential candidate updated his/her user profile in an online social network makes the potential candidate a more likely candidate for assigning to the nurture flow.

In an embodiment, the profile of a successful candidate is used to compare against other user profiles to determine whether any of the other user profiles match the profile of the successful candidate. In this way, the profile of that one successful candidate is used to predict which potential candidates are most likely to perform an intended action of a nurture flow and, therefore, should be targeted.

The profile of the successful candidate may be selected in any fashion, such as selecting the first successful candidate of a nurture flow, selecting the most recent successful candidate of the nurture flow, selecting the “fastest” successful candidate (i.e., one that performed an intended action of the nurture flow in the shortest time from when the candidate was assigned to the nurture flow), or randomly.

In an embodiment, profiles of some successful candidates are eliminated from consideration based on one or more criteria. For example, 95% of successful candidates may have a particular job title but only 3% of all candidates that (1) have the particular job title and (2) were assigned to the corresponding nurture flow performed the intended action. Therefore, the particular job title may not be determinative of success. As another example, 5% of successful candidates may have be in a particular industry, but 85% of all candidates that (1) are in the particular industry and (2) were assigned to the corresponding nurture flow performed the intended action. In this example, a candidate's industry is determinative of success.

A ratio of (a) successful candidates with a particular attribute value to (b) all candidates that have the particular attribute value and that have been assigned to the corresponding nurture flow may be determined. This ratio is referred to herein as a “determinative ratio.” An attribute value associated with a relatively high determinative ratio may be a factor in selecting matching profiles. For example, if the determinative ratio associated with the particular attribute value is above a certain threshold (e.g., 50%), then potential candidates that are associated with the particular attribute value (and zero of more other “highly” determinative attribute values) are identified.

### Creating a General Profile

In a related embodiment, a general profile of successful candidates who successfully performed the intended action of a nurture flow is generated. The general profile is then compared to profiles of potential candidates to determine whether any of the profiles match the general profile. Thus, a general profile represents multiple successful candidates and is used to predict which potential candidates are most likely to perform an intended action of a nurture flow.

In an embodiment, for each of one or more attributes in a general profile, the general profile includes all (or a subset of) attributes values of the successful candidates associated with the general profile. For example, a general profile may include a job title attribute that lists the job titles of all (or a subset of) the successful candidates. As another example, a general profile may include a connection attribute that indicates a range of a number of connections (e.g., between ninety-two and three hundred) that successful candidates have in one or more social networks.

Additionally or alternatively, for each of one or more attributes in a general profile, the general profile includes a single attribute value, such as a minimum threshold of connections, a single job title, and the most recent prior employer. Thus, attribute values of some successful candidates may be excluded from the general profile. In this embodiment, the most common value of a particular attribute may be selected for inclusion in the general profile. For example, if 40% of successful candidates have a first job title, 35% of successful candidates have a second job title, and 25% of successful users have a third job title, then the first job title is selected for inclusion in the general profile. Alternatively, the determinative ratio of various attribute values may be used to determine which attribute value to include in a general profile.

In an embodiment, a general profile is generated based on successful candidates from multiple nurture flows. For example, if a recruiter initiated the creation of three nurture flows, then a general profile may be created based on all (or a subset of) successful candidates from all three nurture flows. In a related embodiment, a general profile is only created based on successful candidates of nurture flows that are associated with the same intended action (or same type of intended action). Thus, in the most recent example, if only two of the three nurture flows are associated with the same intended action, then only profile data of the successful candidates from those two nurture flows are used to generate a general profile.

Regardless of how a general profile is created, the general profile may be associated with the nurture flow through which the successful candidates completed. Additionally or alternatively, a general profile is associated with the entity that established the corresponding nurture flow(s).

In a related embodiment, a general profile is created based on the same or similar intended actions or the same or similar types of job positions that are the subject of the intended actions. Thus, not only might the successful candidates of the general profile be associated with different nurture flows, the successful candidates may be associated with different nurture flows from different entities (e.g., recruiters). For example, two nurture flows are created by different recruiters that are searching for candidates with backgrounds in nuclear engineering. Recruiting system 140 may generate a general profile that is based on successful candidates from both nurture flows.

### Weighted Profile Attributes

In an embodiment, when performing a comparison between two profiles, some profile attributes may be considered while other profile attributes may be ignored, such as residence information, hobbies, gender, or number of connections. In a related embodiment, some profile attributes may have a higher weighting than other attributes, such as job title, work industry, undergraduate degree, graduate institution, number of connections in a particular industry, place of residence, gender, second language, skills, current employer, previous employer, and employment status.

A weight for an attribute (or attribute value) may be manually specified by, for example, the entity that established a nurture flow or a representative of recruiting system 140. Alternatively, a weight for an attribute (or attribute value) may be based on attribute values of successful candidates or a determinative ratio for an attribute value. For example, for a particular nurture flow, a determinative ratio for a first job title is below a threshold while a determinative ratio for a second job title is above the threshold. Thus, users having the first job title may not be weighted as high as users having the second job title.

After attribute values of two profiles are compared, a similarity score is generated to reflect how similar the two user profiles are. If different attributes are associated with different weights or priorities, then a match of a higher priority attribute will have a greater effect on the similarity score than a match of a lower priority attribute.

### Identifying Potential Candidates

A user whose profile has a similarity score above a certain threshold is considered a potential candidate. Because a user's profile may be compared to multiple general profiles, the user may be a potential candidate for some entities (e.g., recruiters) but not for other entities.

The threshold similarity score above which a user is considered a potential candidate may vary from entity to entity or even from nurture flow to nurture flow. For example, one recruiter may set a threshold similarity score to 0.95 (on a scale from ‘0’ to ‘1’, ‘1’ being an exact match) and another recruiter may set a threshold similarity value to 0.82.

As another example, a recruiter may set a threshold similarity score to 0.9 for a first nurture flow and 0.8 for a second nurture flow. In this example, if a potential candidate matches a profile (whether general or specific) for the first nurture flow, then the potential candidate is associated with the first nurture flow. Similarly, if a potential candidate matches a profile (whether general or specific) for the second nurture flow, then the potential candidate is associated with the second nurture flow.

In an embodiment, a potential candidate is immediately assigned to a nurture flow. Alternatively, information about one or more potential candidates is displayed to an entity associated with the potential candidate. For example, a recruiter may log into recruiting system 140 and request information about potential candidates for a particular nurture flow. In response, recruiting system 140 displays a list of names. To keep the names confidential, profile identifiers may be displayed in place of first and/or last names. The list may be ordered based on any criteria, such as similarity scores, such that potential candidates associated with high similarity scores are listed higher than potential candidates associated with lower similarity scores. The recruiter may select individual names (or profile IDs) to view profile information about the selected potential candidate. The recruiter may provide input that selects one or more potential candidates from the list for current content targeting.

### Model Approach

The techniques described previously regarding identifying potential candidates through comparing profiles of successful candidates (or a composite profile representing multiple successful candidate) with profiles of non-candidates is one approach for identifying potential candidates. Additionally or alternatively, potential candidates are identified using a predictive modeling approach.

Thus, in an embodiment, a model is created, trained, and is used to identify potential candidates (or rank “actual” candidates). Attributes associated with a user are inputs to the model, which outputs a score that is used to determine whether to consider the user as a potential candidate and, thus, add the user to a nurture flow. In modeling parlance, the attributes that are used to train a model and are input to the trained model are referred to as “feature values,” which correspond to “features” that the model is configured to track.

Supervised learning is a type of machine learning task that involves inferring a function from labeled training data. One type of supervised learning involves classification (where the output is a category, such as “successful” or “unsuccessful”) and another type of supervised learning involves regression (where the output is a continuous value, such as between 0 and 1). Embodiments are not limited to the type of machine learning that is used to create and train the model.

In one approach, a model is trained using labeled data. For example, some labeled data may be of successful candidates and other labeled data may be of unsuccessful candidates. Thus, the model is trained to learn the features that are determinative of successful candidates and the features that are not.

Examples of types of features that may be used to train the model include user profile data and online user behavior. Examples of user profile data items include current and past job titles, current and past employers, academic degrees achieved, education institutions attended, current employment status, types and number of skills, types and number of endorsements, places lived, hobbies, personal interests, number of friends or connections in a social network, number of connections the user has in a social network, number of connections with a certain class or group of users (e.g., executives, lawyers, or IT professionals).

Examples of online user behavior include number of connections made within the last week, number of posts by the user, number of comments by the user regarding content items provided by other user, number of “likes” by the user of content items provided by other users, types and number of web pages and/or web sites that the user visited, number of logins of the user to a website (e.g., a social networking website), number of invitations the user sent to others to connect in a social network, number of invitations the user received from others to connect in a social network, number of invitations the user sent to others that were declined, number of invitations received that the user declined, an online reputation score of the user, views of job postings, applications to jobs, updates of the user's profile, code committed to an online repository (e.g. GitHub), content or sentiment of messages shared online (e.g. LinkedIn status updates, tweets), online search activity, user interaction with content items provided by companies, company follow activity, user activity within a 3rd party applicant tracking system, consumption of online educational content, and types and number of views of the user's online profile.

### Multiple Models

In an embodiment, multiple models are created and trained. A different model may be created and trained for each nurture flow. Thus, if multiple nurture flows are established by or for a single recruiter, then a model is created and trained for each of the recruiter's nurture flows. Alternatively, a different model is created and trained for each recruiter, but a single model may be used to identify multiple potential candidates (or rank identified candidates) for multiple nurture flows established by or for a single recruiter. Alternatively, a single model is created and trained for multiple nurture flows established by or for multiple recruiters.

### Training Data

A model may be trained using different types of candidates (“successful” or “unsuccessful”), labeled as such. In one approach, all known (or at least labeled) successful candidates and unsuccessful candidates are used to train a model. In another approach, a subset of all successful candidates and a subset of all unsuccessful candidates are used to train a model.

If there are multiple models, then the models are trained based on successful and unsuccessful candidates from the corresponding nurture flows. For example, if a model is created and trained for nurture flow A, then successful and unsuccessful candidates associated with nurture flow A are used to train the model. As another example, if a model is created and trained for nurture flows that are similar to nurture flows B and C (but that may not yet be created), then successful and unsuccessful candidates associated with nurture flows B and C are used to train the model.

Some unsuccessful candidates may have been candidates for multiple nurture flows (whether established for the same or different job position). If, for example, multiple instances of an unsuccessful candidate are used to train a model, then the model may be trained “too much” for that one unsuccessful candidate and, as a result, the model may not detect other users as potential unsuccessful candidates.

### Validation

In an embodiment, a model is validated by selecting a number of data sets (or sets of successful and/or unsuccessful candidates) and applying them as input to the model. Each data set is also labeled, such as successful candidates or unsuccessful candidates. The model generates a score that indicates whether a user is likely to be successful candidate or unsuccessful candidate and that result is compared to the correct answer. If the model is correct a certain percentage of the time (e.g., 99%), then the model is deemed validated and ready for use in production to identify potential candidates from among a set of users.

Additionally or alternatively, a model is trained by presenting model results to a user, such as a recruiter or subject matter expert. The user classifies each model result, such as accepting or rejecting a model result (i.e., a binary label) or classifying a model result as belonging to one of three or more categories.

If the model is not correct a threshold percentage of the time, then the model is not ready for production. One of multiple approaches may be used at this point. In one approach, a new model is created and trained on a different set of training data, such as randomly-selected known successful candidates and/or known unsuccessful candidates. In another approach, the non-validated model is trained based on additional candidates that are considered similar to the candidates that the model incorrectly scored.

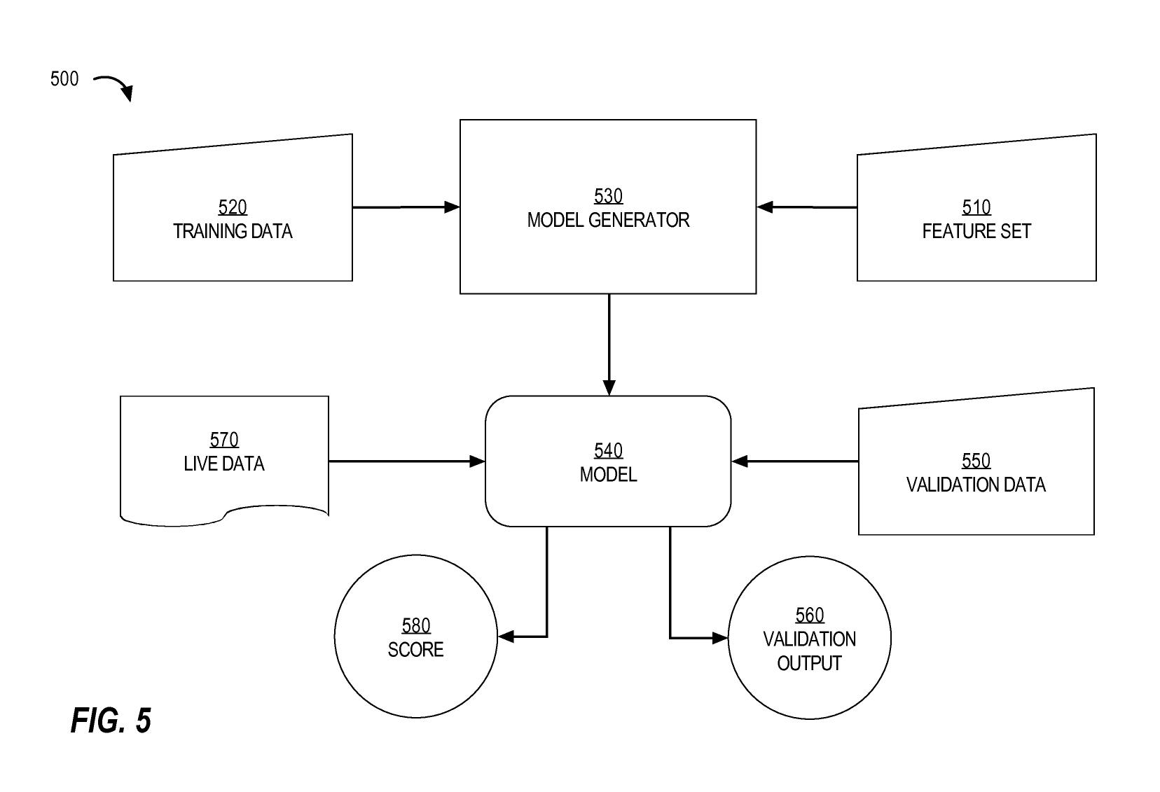

FIG. 5 is a block diagram that depicts a process 500 for generating, training, and using a model for identifying potential candidates, in an embodiment. Process 500 may be implemented by one or more components of recruiting system 140.

Feature set 510 is provided as input to model generator 530. Feature set 510 may be specified by one or more users.

Training data 520 is provided as input to model generator 530. Training data 520 comprises data about multiple successful and/or unsuccessful candidates, labeled as such. The data sets in training set 510 may have been gathered over a long period of time or may be restricted to only candidates that have been “seen” (or received by recruiting system 140) over a relatively recent period of time (e.g., one year).

Model generator 530 analyzes training data 520 based on the features indicated in feature set 510. Output of model generator 530 is model 540.

Before using model 540 to identify potential candidates, model 540 is validated based on validation data 550, which includes data about multiple candidates, although the number of candidates indicated in validation data 550 may be much less (e.g., three times less) than the number of candidates indicated in training data 520. Model 540 generates validation output 560 that indicates a score for each candidate indicated in validation data 550.

Although FIG. 5 depicts model 540 as receiving validation data 550 and live data 570, a different version of model 540 may receive and process live data 570 than the version that received and processed validation data 550. Thus, an analysis of validation output 560 may indicate that model 540 is not ready for production or for identifying potential candidates. Therefore, model generator 530 or another component (not depicted) may refine or further modify model 540.

A score threshold may be selected after model 540 is validated based on analyzing validation output 560. Once an acceptable score threshold is selected, live data 570 (comprising multiple user profiles and/or online behavior of the users) is provided as input to model 540, which produces score 580 for each user.

### Selecting a Score Threshold

As described previously, the model outputs a score. In order to determine whether to categorize the corresponding user as a potential candidate, the score is interpreted, such as by determining whether the score is greater than (or less than) a particular threshold. If so, then the corresponding user is identified as a potential candidate and is assigned to a nurture flow associated with the model. Information about the same user may be input into multiple models if multiple models exist. Thus, a single user may be considered a potential candidate with respect to one nurture flow, but not with respect to another nurture flow.

In an embodiment, a model's score threshold is updatable. For example, later, if emphasis is being placed on targeting content to more candidates, then the score threshold may be decreased. Alternatively, if monetary resources required to target candidates are depleting, then the score threshold may be increased. Such a modification of the score threshold may be manual or automatic. For example, certain inputs may be used to determine whether to increase or decrease the score threshold.

In an embodiment, a score for each user may be used to rank or prioritize the users relative to each other. For example, the top fifty users in terms of score are identified as potential candidates.

### Scoring Candidates Using a Model

In an embodiment, a model is used to rank or score candidates that have been identified based on a search initiated, for example, by a recruiter. For example, 50 candidates are that satisfy one or more job criteria are identified. For each of the 50 candidate, information about the candidate is input into the model to determine a score for the candidate. The information may be user profile data and/or online user behavior data associated with the candidate.

A candidate's score may be used in one or more of the following ways. In one approach, a candidate's score is used to determine to which nurture flow (from among multiple nurture flows) the candidate will be assigned. For example, a recruiter has established two nurture flows: one for candidates with a score greater than or equal to 0.5 and another for candidates with a score less than 0.5. The two nurture flows may be different in terms of number of segments, the segment advancement criteria, the recruiting-related content, and/or number and/or types content delivery channels.

In another approach, a candidate's score is used to determine to which segment of a nurture flow the candidate will be assigned. For example, candidates with a score less than 0.33 are assigned to the first segment in a nurture flow, candidates with a score greater than or equal to 0.33 and less than 0.66 are assigned to the second segment in the nurture flow, and candidates with a score greater than or equal to 0.66 are assigned to the third segment in the nurture flow.

In another approach, a candidate's score is used when determining whether to advance the candidate from one segment to another segment in a nurture flow. For example, segment advancement criteria of a particular segment in the nurture flow may be that a candidate is to advance to a subsequent segment if (a) (1) a particular advertisement was presented to the candidate and (2) the candidate has a score greater than 0.8 or (b) the candidate has viewed a particular video. As another example, the higher the score, the less time the candidate is assigned to a particular segment (or to any segment) in a nurture flow.

In another approach, a candidate's score is used to determine which recruiting-related content to target to the candidate. For example, a targeting parameter of a particular segment in a nurture flow may be that first recruiting-related content is to be displayed to a candidate if the candidate's score is greater than or equal to 0.6 and that second recruiting-related content is to be displayed to the candidate if the candidate's score is less than 0.6.

In another approach, a candidate's score is used to determine which content delivery channel to select while the candidate is assigned to a particular segment in a nurture flow. For example, a first content delivery channel is selected for delivering particular recruiting-related content if a candidate's score is greater than or equal to 0.5 while a second (different) content delivery channel is selected for delivering the particular recruiting-related content if the candidate's score is less than 0.5.

In another approach, a candidate's score is used to determine how many resources to devote to the candidate. For example, the higher a candidate's score, the more budget of a recruiting campaign to spend on the candidate. Conversely, the lower a candidate's score, the less budget is spent on the candidate. For example, multiple sponsored updates are presented to candidates (assigned to a particular segment in a nurture flow) who have a score above 0.7 via a homepage feed provided by the respective candidate's social network provider, while a single sponsored update is presented to candidates who have a score below 0.7. Different ranges of scores may correspond to a different amount of money to allocate to candidates having scores in those ranges.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

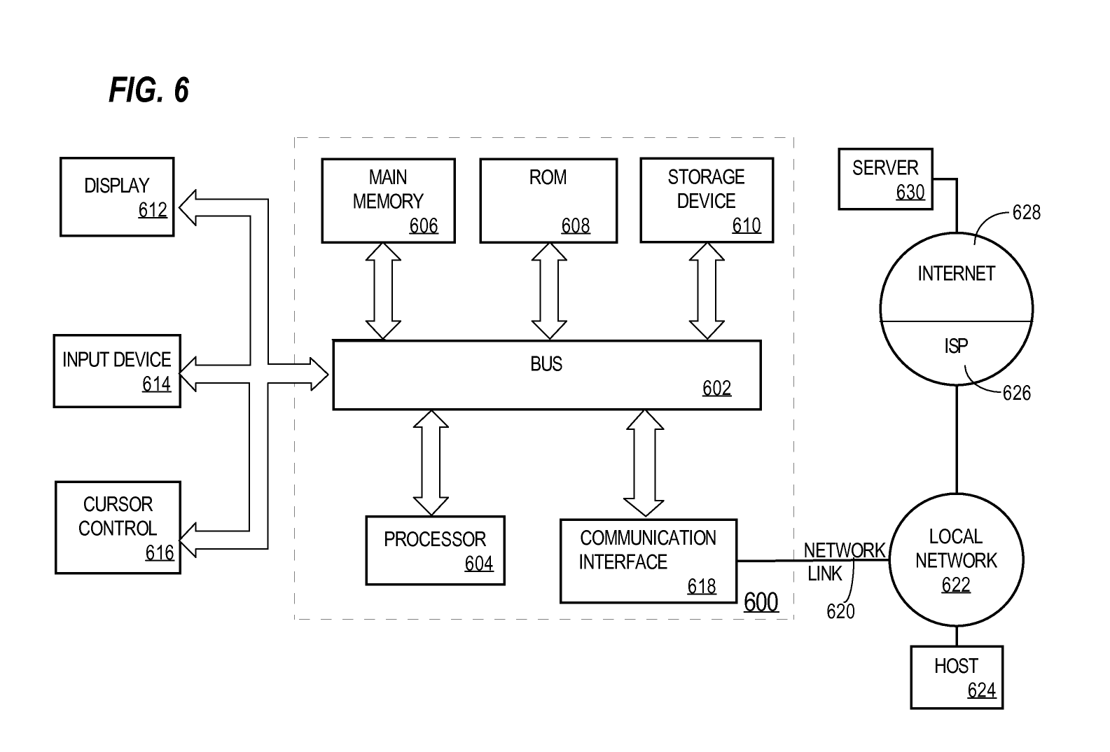

For example, FIG. 6 is a block diagram that illustrates a computer system 600 upon which an embodiment may be implemented. Computer system 600 includes a bus 602 or other communication mechanism for communicating information, and a hardware processor 604 coupled with bus 602 for processing information. Hardware processor 604 may be, for example, a general purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk or optical disk, is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 610. Volatile media includes dynamic memory, such as main memory 606. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

1. A method for nurturing potential candidates for one or more job openings, the method comprising:
storing profile data of a plurality of members of a social network;
receiving input that indicates one or more search criteria;
in response to receiving the input, identifying, based on the one or more search criteria and the profile data, a subset of the plurality of members as a recruiter pool of candidates for the one or more job openings;
prior to any member in the subset joining an organization that is associated with a nurture flow or that is associated with the one or more job openings:
assigning each member in the subset to a first segment in the nurture flow that comprises a plurality of segments that includes the first segment and a second segment that is different than the first segment, wherein the first segment comprises one or more first targeting parameters;
while a first member in the subset is assigned to the first segment, automatically:
determining the one or more first targeting parameters that are associated with the first segment;
identifying first recruiting-related content based on the one or more first targeting parameters;
causing the first recruiting-related content to be presented to the first member;
after causing the first recruiting-related content to be presented to the first member, determining whether one or more segment advancement criteria that are associated with the first segment are satisfied;
in response to determining that the one or more segment advancement criteria that are associated with the first segment are satisfied, automatically assigning the first member from the first segment to the second segment;
while the first member in the subset is assigned to the second segment in the plurality of segments, automatically:
determining one or more second targeting parameters that are associated with the second segment;
identifying second recruiting-related content based on the one or more second targeting parameters;
causing the second recruiting-related content to be presented to the first member;
wherein the method is performed by one or more computing devices.

2. (canceled)

3. The method of claim 1, further comprising, prior to assigning the first member to the first segment of the nurture flow:
identifying a plurality of nurture flows that includes the nurture flow, wherein each nurture flow in the plurality of nurture flows comprises one or more segments;
selecting, based on one or more criteria, the nurture flow from among the plurality of nurture flows.

4. The method of claim 1, wherein:
causing the first recruiting-related content to be presented to the first member comprises sending, over a network to a first computing system, targeting instruction data that indicates the first member and the first recruiting-related content;
the first computing system causes the first recruiting-related content to be presented, to the first member, within web content that the first computing system provides and that the first member requests.

5. The method of claim 4, wherein the targeting instruction data includes the first recruiting-related content.

6. The method of claim 4, wherein one of the one or more targeting parameters indicates the first computing system.

7. The method of claim 4, further comprising:
selecting, based on member profile data of the first member, to use the first computing system from among a plurality of third-party computing systems to deliver the first recruiting-related content to the first member.

8. A method for nurturing potential candidates for one or more job openings, the method comprising:
storing profile data of a plurality of members of a social network;
receiving input that indicates one or more search criteria;
in response to receiving the input, identifying, based on the one or more search criteria and the profile data, a subset of the plurality of members as a recruiter pool of candidates for the one or more job openings;
prior to any member in the subset joining an organization that is associated with a nurture flow or that is associated with the one or more job openings:
assigning each member in the subset to a first segment in the nurture flow, wherein the first segment comprises one or more first targeting parameters;
while a first member in the subset is assigned to the first segment:
determining the one or more first targeting parameters that are associated with the first segment;
identifying first recruiting-related content based on the one or more first targeting parameters;
causing the first recruiting-related content to be presented to the first member;
wherein causing the first recruiting-related content to be presented to the first member comprises sending, over a network to a first computing system, first targeting instruction data that indicates the first member and the first recruiting-related content;
wherein the first computing system uses the first targeting instruction data to determine that a first request is associated with the first member and, in response, cause the first recruiting-related content to be presented to the first member;
wherein the nurture flow comprises a plurality of segments that includes the first segment and a second segment that is different than the first segment;
wherein each segment of the plurality of segments comprises one or more targeting parameters;
wherein the method further comprising, while the first member in the subset is assigned to the second segment in the plurality of segments:
determining one or more second targeting parameters that are associated with the second segment;
identifying second recruiting-related content based on the one or more second targeting parameters;
causing the second recruiting-related content to be presented to the first member;
wherein causing the second recruiting-related content to be presented to the first member comprises sending, over the network to a second computing system that is different than the first computing system, second targeting instruction data that indicates the first member and the second recruiting-related content;
wherein the second computing system uses the second targeting instruction data to determine that a second request is associated with the first member and, in response, cause the second recruiting-related content to be presented to the first member;
wherein the method is performed by one or more computing devices.

9. The method of claim 1, wherein the one or more first targeting parameters indicate a first delivery channel through which the first recruiting-related content will be presented to the particular user.

10. The method of claim 1, further comprising:
assigning a second member of the subset to a particular segment in a second nurture flow that comprises multiple segments;
receiving update data that indicates a change in a social profile, maintained by an online social network service, of the second member, wherein the second member provided at least a subset of data within the social profile to the online social network service;
in response to receiving the update data, assigning the second member to a different segment in the second nurture flow.

11. The method of claim 10, wherein the change is a new connection or contact, in a social network provided by the online social network service, to the second member.

12. The method of claim 1, wherein:
each segment of one or more segments in the plurality of segments comprises one or more targeting parameters and one or more advancement criteria that indicates whether to assign a member, that is assigned to said each segment, to another segment in the plurality of segments.

13. The method of claim 12, wherein the first segment is associated with one or more segment advancement criteria, the method further comprising:
while the first member is assigned to the first segment, determining whether the one or more segment advancement criteria are satisfied;
in response to determining that the one or more segment advancement criteria are satisfied, assigning the first member to the second segment.

14. The method of claim 12, wherein the one or more segment advancement criteria includes one or more of a member selecting an advertisement about a particular employer that specified the input, the member visiting a web site provided by the particular employer, the member providing input to the web site or to a third-party platform, or a time that the member has been assigned to the first segment.

15. The method of claim 1, further comprising:
while the first member is assigned to a third segment that is different than the first segment, determining whether one or more criteria are satisfied;
in response to determining that the one or more criteria are satisfied, sending, to a recruiting tool operated by a user that is different than any member in the subset and that is associated with the organization, a notification that identifies the first member and one or more attributes of the first member, wherein the user uses the recruiting tool to send one or more messages to the first member.

16. A system for nurturing potential candidates for one or more job openings, the system comprising:
one or more processors;
one or more storage media storing instructions which, when executed by the one or more processors, cause:
storing profile data of a plurality of members of a social network;
receiving input that indicates one or more search criteria;
in response to receiving the input, identifying, based on the one or more search criteria and the profile data, a subset of the plurality of members as a recruiter pool of candidates for the one or more job openings;
prior to any member in the subset joining an organization that is associated with a nurture flow or that is associated with the one or more job openings:
assigning each member in the subset to a first segment in the nurture flow that comprises a plurality of segments that includes the first segment and a second segment that is different than the first segment, wherein the first segment comprises one or more first targeting parameters;
while a first member in the subset is assigned to the first segment, automatically:
determining the one or more first targeting parameters that are associated with the first segment;
identifying first recruiting-related content based on the one or more first targeting parameters;
causing the first recruiting-related content to be presented to the first member;
while the first member in the subset is assigned to the second segment in the plurality of segments:
determining one or more second targeting parameters that are associated with the second segment;
identifying second recruiting-related content based on the one or more second targeting parameters;
causing the second recruiting-related content to be presented to the first member.

17. (canceled)

18. The system of claim 16, further comprising, prior to assigning the first member to the first segment of the nurture flow:
identifying a plurality of nurture flows that includes the nurture flow, wherein each nurture flow in the plurality of nurture flows comprises one or more segments;
selecting, based on one or more criteria, the nurture flow from among the plurality of nurture flows.

19. The system of claim 16, wherein:
causing the first recruiting-related content to be presented to the first member comprises sending, over a network to a first computing system, targeting instruction data that indicates the first member and the first recruiting-related content;
the first computing system causes the first recruiting-related content to be presented, to the first member, within web content that the first computing system provides and that the first member requests.

20. The system of claim 16, the instructions, when executed by the one or more processors, further cause:
assigning a second member of the subset to a particular segment in a second nurture flow that comprises multiple segments;
receiving update data that indicates a change in a social profile, maintained by an online social network service, of the second member, wherein the second member provided at least a subset of data within the social profile to the online social network service;
in response to receiving the update data, assigning the second member to a different segment in the second nurture flow.

21. The system of claim 16, wherein:
each segment of one or more segments in the plurality of segments comprises one or more targeting parameters and one or more advancement criteria that indicates whether to assign a member, that is assigned to said each segment, to another segment in the plurality of segments;
the first segment is associated with one or more segment advancement criteria;
the instructions, when executed by the one or more processors, further cause:
while the first member is assigned to the first segment, determining whether the one or more segment advancement criteria are satisfied;
in response to determining that the one or more segment advancement criteria are satisfied, assigning the first member to the second segment.

22. The system of claim 21, wherein the one or more segment advancement criteria includes one or more of a member selecting an advertisement about a particular employer that specified the input, the member visiting a web site provided by the particular employer, the member providing input to the web site or to a third-party platform, or a time that the member has been assigned to the first segment.

23. The system of claim 19, wherein:
causing the second recruiting-related content to be presented to the first member comprises sending, over the network to a second computing system that is different than the first computing system, second targeting instruction data that indicates the first member and the second recruiting-related content;
the second computing system causes the second recruiting-related content to be presented, to the first member, within web content that the second computing system provides and that the first member requests.

24. The method of claim 1, further comprising, prior to automatically assigning the first member to the second segment:
detecting a change in a social graph that is maintained by an online social network service with which the first member is registered;
in response to detecting the change in the social graph, determining to assign the first member to the second segment.

25. The method of claim 24, wherein the change include a new connection being created between the first member and another member of the online service network service.
